(19) United States
(12) Patent Application Publication
(10) Pub. No.: US 2025/0023212 A1
(43) Pub. Date: Jan. 16, 2025

(54) Commercial Battery Overcurrent Protective Device

(71) Applicants: Justin Chasteen, Sioux City, IA (US); Troy Askelson, Hinton, IA (US)

(72) Inventors: Justin Chasteen, Sioux City, IA (US); Troy Askelson, Hinton, IA (US)

(21) Appl. No.: 18/589,687

(22) Filed: Feb. 28, 2024

Related U.S. Application Data
(60) Provisional application No. 63/526,137, filed on Jul. 11, 2023.

(51) Int. Cl. H01M 50/583; H01M 50/51

(52) U.S. Cl. CPC H01M 50/583; H01M 50/51; H01M 2200/103

(57) ABSTRACT

A commercial battery overcurrent protective device includes an elongated panel. The panel is comprised of a non-conductive material. Each of a pair of battery lugs is positioned adjacent to a respective one of opposite ends of the panel. Each of a pair of mounting brackets is coupled to an associated one of the pair of battery lugs. A power overload protector is coupled to and extends between the mounting brackets. The pair of battery lugs, the mounting brackets, and the power overload protector are electrically connected to define an electrical path. Each battery lug extends outwardly from the respective one of the opposite ends of the panel for coupling to a terminal of an associated cell of a pair of cells in series within a commercial battery. Thus, the power overload protector breaks the electrical path and interrupts electrical connection of the cells in series upon overcurrent within the commercial battery.

### CROSS-REFERENCE TO RELATED APPLICATIONS

I hereby claim the benefit under 35 U.S.C. Section 119 (e) of U.S. Provisional application 63/526,137 filed Jul. 11, 2023.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to overload protections devices and more particularly pertains to a new overcurrent protection device for overcurrent protection in a commercial size battery interconnecting multiple cells.

### (2) Description of Related Art Including Information Disclosed Under 37 CFR 1.97 and 1.98

The prior art relates to overload protections devices but lacks an overload protections device for interconnection in the serial or parallel connection of multiple cells of a commercial battery, and further lacks the provision of a rigid panel to maintain a rigid connection when the overload protections device is broken by an overcurrent event.

### BRIEF SUMMARY OF THE INVENTION

An embodiment of the disclosure meets the needs presented above by generally comprising a panel elongated between opposite ends of the panel. The panel is comprised of a non-conductive material. Each of a pair of battery lugs is positioned adjacent to a respective one of the opposite ends of the panel. Each of a pair of mounting brackets is coupled to an associated one of the pair of battery lugs. A power overload protector is coupled to and extends between the mounting brackets. The pair of battery lugs, the mounting brackets, and the power overload protector are electrically connected to define an electrical path. Each battery lug extends outwardly from the respective one of the opposite ends of the panel for coupling to a terminal of an associated cell of a pair of cells in series within a commercial battery. Thus, the power overload protector breaks the electrical path and interrupts electrical connection of the cells in series upon overcurrent within the commercial battery.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top view of a commercial battery overcurrent protective device according to an embodiment of the disclosure.

FIG. 2 is a front view of an embodiment of the disclosure.

FIG. 3 is a top view of an embodiment of the disclosure.

FIG. 4 is a front view of an embodiment of the disclosure.

FIG. 5 is a rear view of an embodiment of the disclosure.

FIG. 6 is a top view of an embodiment of the disclosure.

FIG. 7 is a top view of an embodiment of the disclosure.

### DETAILED DESCRIPTION OF THE INVENTION

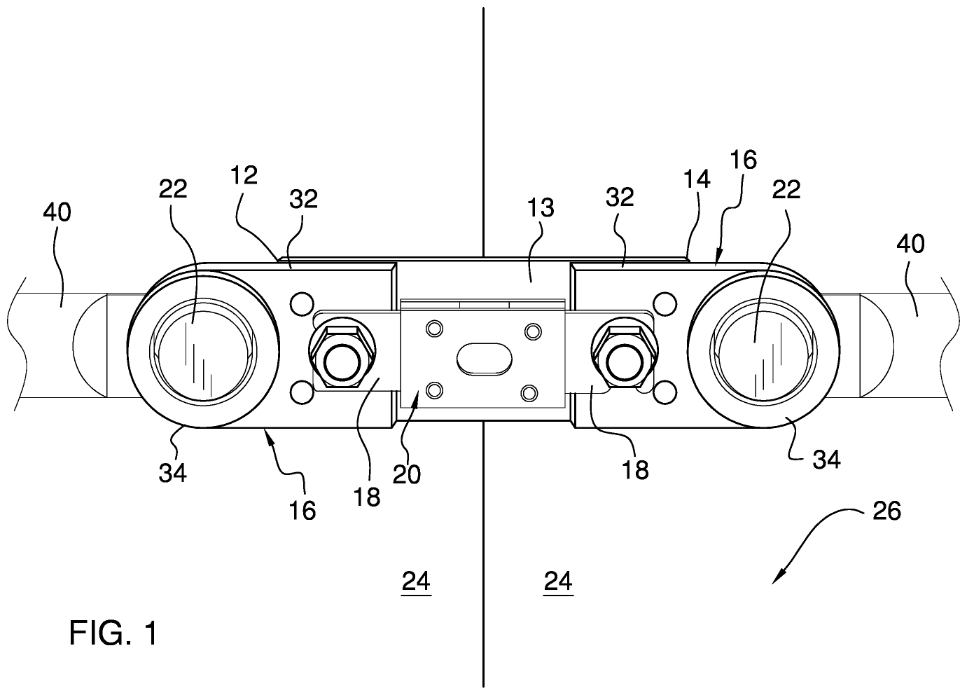

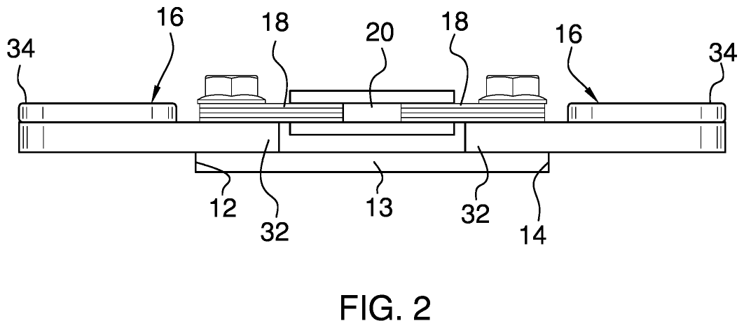

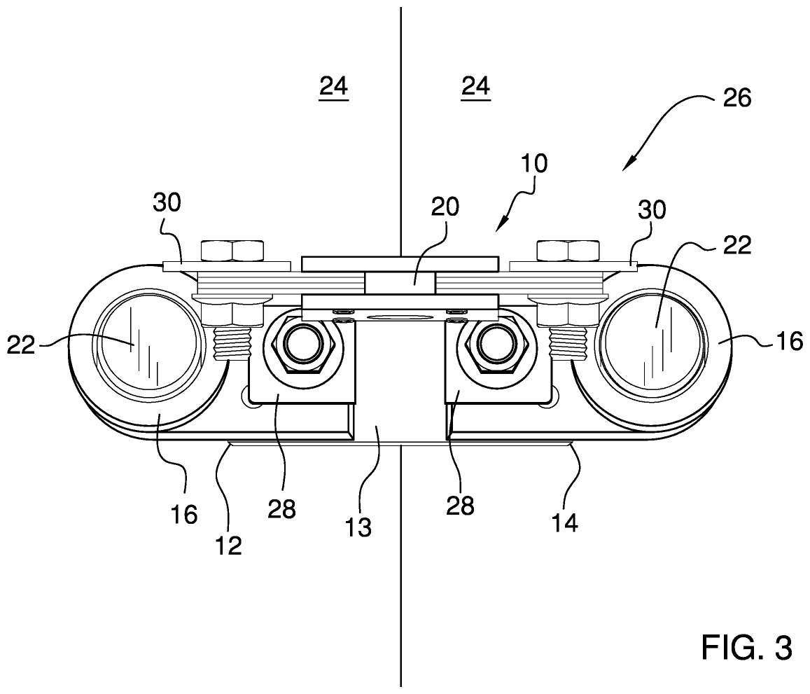

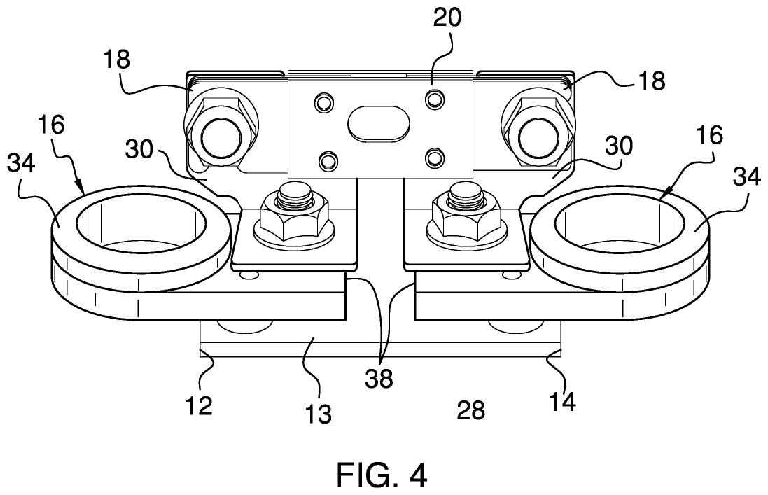

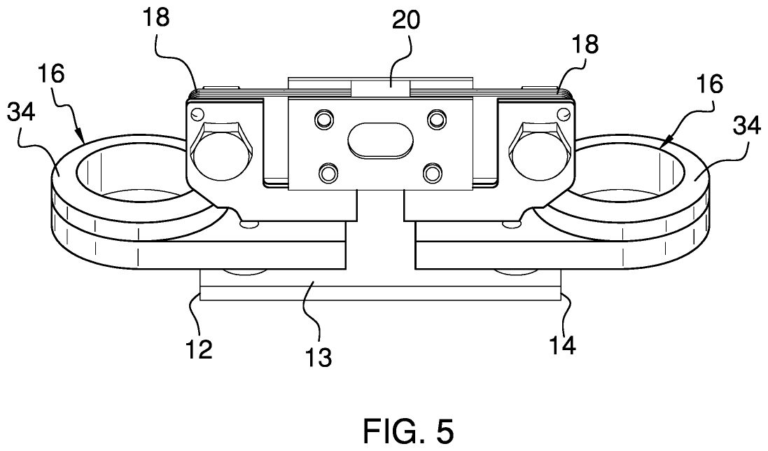

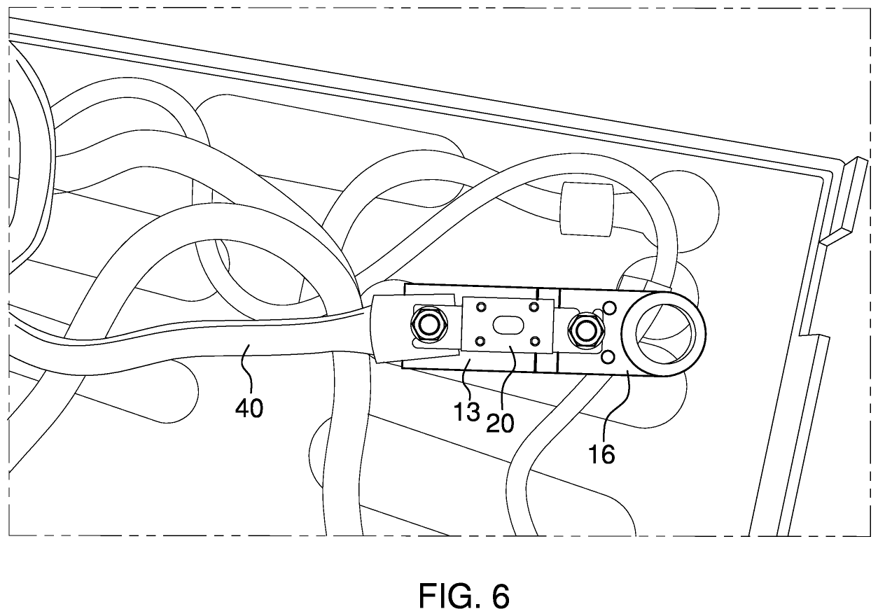

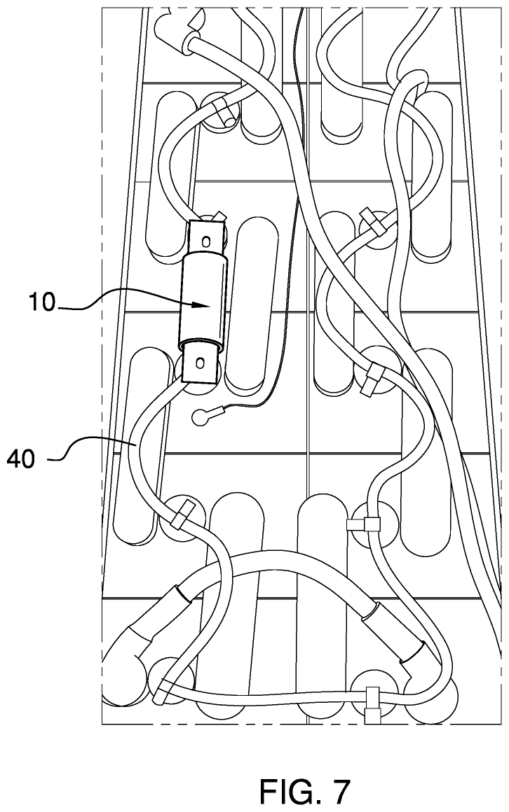

With reference now to the drawings, and in particular to FIGS. 1 through 7 thereof, a new overcurrent protective device embodying the principles and concepts of an embodiment of the disclosure and generally designated by the reference numeral 10 will be described.

As best illustrated in FIGS. 1 through 7, a commercial battery overcurrent protective device 10 generally comprises a panel 13. The panel 13 is elongated between opposite ends 12,14 of the panel 13. The panel 13 is comprised of a non-conductive material. This may be paper, glass, rubber, porcelain, ceramic, plastic, or the like which does not allow for conduction of electricity through the material. Each of a pair of battery lugs 16 is positioned adjacent to a respective one of the opposite ends 12,14 of the panel 13. Each of a pair of mounting brackets 18 is coupled to an associated one of the pair of battery lugs 16. The connections between the panel 13, the battery lugs 16, the mounting brackets 18, and power overload protector 20 may be fixed using set holes, or adjustable using slots which provide for contraction and expansion and which may be secured by fasteners into a static desired position.

A power overload protector 20 is coupled to and extends between the mounting brackets 18. The power overload protector 20 may be a fuse or a circuit breaker. The pair of battery lugs 16, the mounting brackets 18, and the power overload protector 20 are electrically connected to define an electrical path. Each battery lug 16 of the pair of battery lugs 16 extends outwardly from the respective one of the opposite ends 12,14 of the panel 13 wherein each battery lug 16 is configured for coupling to a terminal 22 of an associated cell 24 of a pair of cells 24 in series within a commercial battery 26, or between the commercial battery 26 and a unit powered by the commercial battery 26. The commercial battery overcurrent protective device 10 can be positioned between any adjacent cells 24 of the commercial battery 26. Each battery lug 16 may be soldered in place or attached by otherwise conventional connecting alternatives. As such, a hole in each battery lug 16 may vary in size to fit a desired terminal 22, be adjustable by way of a conventional bolted connection between opposed flanges, or the like. The power overload protector 20 breaks the electrical path and interrupts electrical connection of the cells 24 in series upon overcurrent within the commercial battery 26. The commercial battery 26 may be of any conventional type including but not limited to lead acid and lithium ion.

The power overload protector 20 is planar. Each mounting bracket 18 of the pair of mounting brackets 18 is also planar. The power overload protector 20 is positioned coplanar with the mounting brackets 18. The mounting brackets 18 and the power overload protector 20 may be oriented parallel to the panel 13.

Alternatively, the mounting brackets 18 and the power overload protector 20 may be oriented perpendicular to the panel 13. Each mounting bracket 18 of the pair of mounting brackets 18 has a lug connection flange 28 perpendicular to a power overload protector connection flange 30. The power overload protector 20 is mounted to extend between the power overload protector connection flanges 30 wherein the power overload protector 20 is positioned coplanar with the power overload protector connection flange 30 of each of the mounting brackets 18 and perpendicular to the panel 13 when the lug connection flanges 28 are coupled to the battery lugs 16.

Each battery lug 16 has a connection portion 32 extending from an annular portion 34. The annular portion 34 of each battery lug 16 is laterally offset from the respective one of the opposite ends 12,14 of the panel 13. The annular portion 34 defines a continuous circle configured for receiving the terminal 22 of the associated cell 24 of the commercial battery 26. The annular portion 34 may be welded to the battery terminal 22 for secure attachment. Alternatively, the annular portion 34 may have a break and tightening flanges joined by a screw in the manner of conventional connection of a battery cable to a terminal of a vehicle battery or the like.

The connection portion 32 of each battery lug 16 has a planar surface 38 extending laterally from the annular portion 34. Each the mounting bracket 18 is coupled to the connection portion 32 of the associated one of the battery lugs 16. This may be achieved by the use of bolts, screws or the other conventional fasteners. The panel 13 is coupled to and extends between the connection portion 32 of each of the battery lugs 16. The panel 13 is rigid and non-conductive. Thus, the panel 13 maintains connection and spacing of the cells 24 of the commercial battery 26 without electrical conduction through the panel 13 upon the power overload protector 20 being broken by overcurrent.

The cells 24 of the commercial battery 26 are conventionally connected by a connecting wire 40. The positioning of the commercial battery overcurrent protective device 10 on the commercial battery 26 is considered best being at or near a mid point along the connections of the cells 24 of the commercial battery 26. For example, if the commercial battery 26 has twenty four total cells 24 the positioning would be between the twelfth and thirteenth cells 24 in series. However, the device 10 will work positioned between any two of the cells 24. or on a cord connecting the commercial battery 26 to a unit to be powered by the commercial battery 26. The annular portion 34 of the battery lugs 16 may be replaced by alternative connection structures should the device 10 be positioned in electrical connection with the series of cells 24 but not directly between adjacent cells 24, such as between a first cell 24 and an end of a connection wire normally connected to the first cell 24, or between a last cell 24 and an end of a connection wire normally connected to the last cell 24.

In use, commercial batteries for lifts and similar heavy duty devices are made by serial connections of multiple cells 24 to form a commercial battery 26. These interconnected cells 24 may be enclosed within a housing. Overcurrent situations can arise producing dangerous results such as fire, chemical or gas release such that prevention of such overcurrent in a commercial battery is needed. The commercial battery overcurrent protective device 10 can be installed on an existing commercial battery or may be produced and sold as an original element for commercial batteries produced in the future. The device 10 is secured in the electrical path of the serial interconnection of the cells of the commercial battery. The power overload protector will break, disconnecting the serial electrical connection upon an overcurrent in the commercial battery. The panel 13 remains in place to keep the cells 24 connected and in a stable position. In larger battery applications multiple commercial battery overcurrent protective devices 10 may be used together.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A commercial battery overcurrent protective device comprising:
a panel, said panel being elongated between opposite ends of said panel, said panel being comprised of a non-conductive material;
a pair of battery lugs, each battery lug of said pair of battery lugs being positioned adjacent to a respective one of the opposite ends of the panel;
a pair of mounting brackets, each mounting bracket of said pair of mounting brackets being coupled to an associated one of said pair of battery lugs;
a power overload protector being coupled to and extending between said mounting brackets;
wherein said pair of battery lugs, said mounting brackets, and said power overload protector are electrically connected to define an electrical path;
wherein each battery lug of said pair of battery lugs extends outwardly from said respective one of said opposite ends of said panel wherein each battery lug is configured for coupling to a terminal of an associated cell of a pair of cells in series within a commercial battery whereby said power overload protector breaks the electrical path and interrupts electrical connection of the cells in series upon overcurrent within the commercial battery.

2. The commercial battery overcurrent protective device of claim 1, further comprising:
said power overload protector being planar;
each mounting bracket of said pair of mounting brackets being planar; and
said power overload protector being positioned coplanar with said mounting brackets.

3. The commercial battery overcurrent protective device of claim 2, further comprising said mounting bracket and said power overload protector being oriented parallel to said panel.

4. The commercial battery overcurrent protective device of claim 1, further comprising:
said power overload protector being planar;
each mounting bracket of said pair of mounting brackets having a lug connection flange perpendicular to a power overload protector connection flange; and
said power overload protector being mounted to extend between said power overload protector connection flanges wherein said power overload protector is positioned coplanar with said power overload protector connection flange of each of said mounting brackets and perpendicular to said panel when said lug connection flanges are coupled to said battery lugs.

5. The commercial battery overcurrent protective device of claim 1, further comprising each battery lug having a connection portion extending from an annular portion, said annular portion of each battery lug being laterally offset from said respective one of said opposite ends of said panel.

6. The commercial battery overcurrent protective device of claim 5, further comprising said annular portion defining a continuous circle configured for receiving the terminal of the associated cell of the commercial battery.

7. The commercial battery overcurrent protective device of claim 5, further comprising said connection portion of each battery lug having a planar surface extending laterally from said annular portion, each said mounting bracket being coupled to said connection portion of said associated one of said battery lugs.

8. The commercial battery overcurrent protective device of claim 7, further comprising said panel being coupled to and extending between said connection portion of each of said battery lugs.

9. The commercial battery overcurrent protective device of claim 1, further comprising said panel being rigid and non-conductive whereby said panel is configured to maintain connection and spacing of the cells of the commercial battery without electrical conduction through the panel.

10. The commercial battery overcurrent protective device of claim 1, wherein the power overload protector is a fuse.

11. The commercial battery overcurrent protective device of claim 1, wherein the power overload protector is a circuit breaker.
